(19) United States
(12) Patent Application Publication
(10) Pub. No.: US 2025/0244356 A1
(43) Pub. Date: Jul. 31, 2025

(54) METHOD FOR OPERATING A SENSOR SYSTEM, APPARATUS FOR PROCESSING SENSOR DATA AND SENSOR SYSTEM

(71) Applicant: Robert Bosch GmbH, Stuttgart (DE)

(72) Inventor: Timo Heikkilä, Hyvinkää (FI)

(21) Appl. No.: 19/012,980

(22) Filed: Jan. 8, 2025

(30) Foreign Application Priority Data
Jan. 26, 2024 (DE) 10 2024 200 721.8

(51) Int. Cl. G01P 21/00; G01P 15/08; G01P 15/18

(52) U.S. Cl. CPC G01P 21/00; G01P 15/08; G01P 15/18

(57) ABSTRACT

A method for operating and calibrating an inertial sensor system. Parameters for a correction model are adjusted for compensating for sensor errors during operation. The parameters can be ascertained by evaluating a course of the speed.

### CROSS REFERENCE

The present application claims the benefit under 35 U.S.C. § 119 of German Patent Application No. DE 10 2024 200 721.8 filed on Jan. 26, 2024, which is expressly incorporated herein by reference in its entirety.

### FIELD

The present invention relates to a method for operating a sensor system, in particular an inertial sensor system. The present invention also relates to an apparatus for processing sensor data, in particular sensor data from an inertial sensor system, and to such a sensor system.

### BACKGROUND INFORMATION

Numerous modern applications, such as navigation systems, require a highly precise determination of position data and trajectories. These position data can be ascertained, for example, by Global Navigation Satellite Systems (GNSS) such as GPS, Galileo, etc. In addition, approaches based on inertial sensor systems are also available, which can determine the motion of an object by means of acceleration sensors along with rotational rate sensors and can derive position changes and thus motion paths from these sensor data.

Furthermore, systems that can execute a determination of position and direction of motion based exclusively on inertial sensor data are increasingly being used.

German Patent Application No. DE 10 2022 205 457 A1 describes sensor systems along with computing units and methods for evaluating sensor data, wherein a drift in the sensor data is ascertained and removed from the measurement data.

### SUMMARY

The present invention provides a method for operating a sensor system, a method for processing sensor data, along with a sensor system. Advantageous example embodiments of the present invention are disclosed herein.

Accordingly, the following is provided according to an example embodiment of the present invention:

A method for operating a sensor system, in particular an inertial sensor system, comprising the following steps. In a first step, a stable state of motion is detected. The decision as to whether the state of motion is stable can be carried out using the sensor data from the sensor system. Furthermore, the method comprises a step of ascertaining a current speed and a current orientation. Here, the speed and orientation can be ascertained using sensor data from the inertial sensor system. Furthermore, the method comprises a step of calculating an average direction of motion and an average orientation of the sensor system. The ascertained values can be calculated for a predetermined time interval or time window. The average values are ascertained using the ascertained current speed and orientation. The method further comprises a step of calculating a difference between a change in a direction of motion and a change in orientation. In addition, the method comprises a step of adjusting parameters for a correction model for compensating for sensor errors of the sensor system. In particular, the parameters for the correction model can be determined using a minimization of the difference between the change in the direction of motion and the change in orientation. The adjustment of the parameters for the correction model is carried out in particular if a stable state of motion has been detected.

Furthermore, the following is provided according to an example embodiment of the present invention:

An apparatus for processing sensor data, in particular sensor data from an inertial sensor system. For this purpose, the apparatus comprises a processing device. The processing device is designed to receive and process sensor data from sensors of the inertial sensor system. Here, in particular, the processing device is designed to carry out the method according to the present invention.

Finally, the following is provided according to an example embodiment of the present invention:

A sensor system having an acceleration sensor, a rotational rate sensor and an apparatus for processing sensor data according to the present invention. The apparatus is designed to receive and process sensor data from the acceleration sensor and the rotational rate sensor.

The present invention makes it possible to increase the efficiency and accuracy of a sensor system based on inertial sensors, in particular acceleration sensors and rotational rate sensors. On the one hand, the present invention makes possible an efficient ascertainment of parameters for compensation of sensor errors. In addition, due to the present invention, the ascertainment of parameters for the compensation of sensor errors can be carried out during operation, for example during the determination of motion data or motion paths.

As a result, the accuracy of the ascertained information regarding a detected motion or position can be increased. In particular, due to the option of dynamic adjustment of the parameters for compensating for sensor errors, good accuracy of the information ascertained can be achieved even over an extended period of time. In addition, the concept presented also makes possible particularly efficient and thus resource-saving processing of the sensor data for position determination and for ascertaining the parameters for error compensation.

Various approaches can be used for assessing the change in the average direction of motion and the change in the average orientation. For example, the difference between the change in the average speed direction and the change in the average orientation of the sensor can be determined over a predefined time interval. Alternatively, it is also possible to determine a difference in the average values between the change in the speed direction and the average values of the change in the orientation of the sensor. Furthermore, a difference between a change in the speed direction and a change in the orientation of the sensor can also be added up over the predefined time interval, for example. Unless otherwise indicated, the direction of motion along with the orientation are preferably used as averaged values for the purposes of the present invention.

According to one example embodiment of the present invention, adjusting the parameters for the correction model is only carried out if the speed is greater than a predetermined threshold value. As a result, it can be ensured that there is a sufficiently significant motion for calibrating the correction model.

According to one example embodiment of the present invention, the method comprises a step of ascertaining inaccuracies of the detected stable state of motion, the average direction of motion and/or the change in orientation. In this case, adjusting the parameters for the correction model can also take these inaccuracies into account. Such inaccuracies can be derived from known tolerances of the sensor values, for example. In addition, the inaccuracies of current data or states during operation, for example, can also be derived from available information. For example, at the beginning or after initialization, a high level of inaccuracy can initially be assumed, which then becomes more accurate over time based on more and more information.

According to one example embodiment of the present invention, the correction model for compensating for sensor errors comprises a probabilistic filter, in particular a Kalman filter. The Kalman filter can be a non-linear Kalman filter, for example an extended Kalman filter or a cubature Kalman filter, in particular a filter designed as a square-root cubature Kalman filter.

According to one example embodiment if the present invention, detecting the stable state of motion is carried out using the available sensor data. Additionally or alternatively, data from other sensors can also be used. For example, patterns or similar features can be identified in the available data that indicate a stable state of motion, such as a uniform path of motion. In addition, any other method for identifying a stable state of motion is of course also possible. The corresponding speed or direction of motion can also be estimated for a stable state of motion. For example, a stable state of motion can be considered to be a motion course in which predefined parameters such as speed vector or the like remain within a tolerance range over a defined period of time.

According to one example embodiment of the present invention, detecting the stable state of motion is carried out using a pre-trained neural network. As a result, even complex data structures can be analyzed, classified and evaluated in a relatively simple manner.

According to one example embodiment of the present invention, calculating the average speed and/or the change in orientation is carried out in each case for a time window of one to three seconds. Such time windows in the range between one and three seconds have proven to be highly suitable for averaging. Depending on the application, any other time window for averaging is of course also possible.

According to one example embodiment of the present invention, calculating the average speed and/or the change in orientation is carried out in each case using a predefined weighting of the individual speed values and/or orientation values. For example, weighting factors can be assigned in each case individually to the individual sensor values within the time window to be observed. In this manner, the dynamics can be adjusted while calculating the averaged value.

The above embodiments and developments can be combined with one another in any manner insofar as is reasonable. Further embodiments, developments, and implementations of the present invention also include combinations, even those not explicitly mentioned, of features of the present invention described above or in the following with regard to the exemplary embodiments. A person skilled in the art will in particular also add individual aspects as improvements or additions to the respective basic forms of the present invention.

### BRIEF DESCRIPTION OF THE DRAWINGS

Further features and advantages of the present invention will be explained in the following with reference to the figures.

FIG. 1 is a schematic representation of a sensor system according to one example embodiment of the present invention.

FIG. 2 is a flow chart of a method for calibrating a sensor system according to one example embodiment of the present invention.

FIG. 3 is a flow chart of a method for calibrating a sensor system according to a further example embodiment of the present invention.

FIG. 4 is a flow chart of a method for processing sensor data according to one example embodiment of the present invention.

FIG. 5 is a flow chart of a method for processing sensor data according to another example embodiment of the present invention.

### DETAILED DESCRIPTION OF EXAMPLE EMBODIMENTS

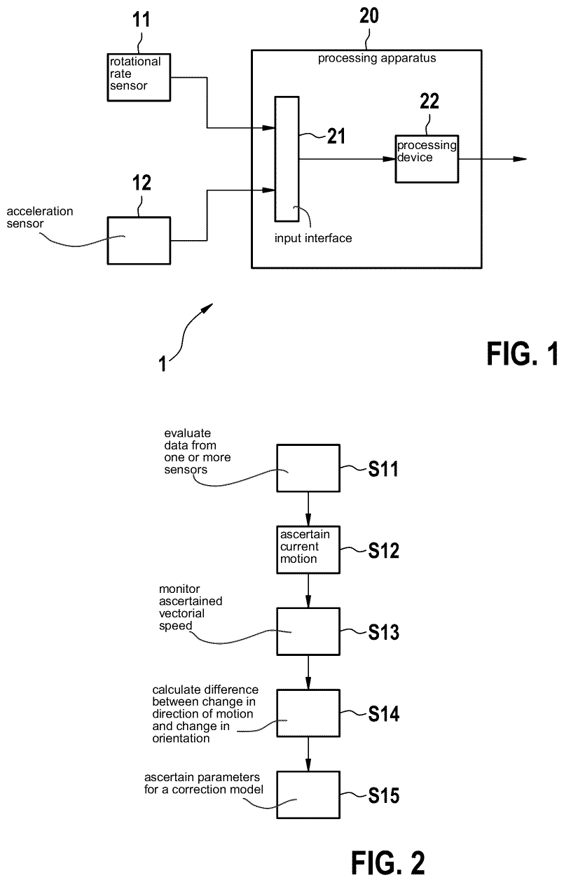

FIG. 1 is a schematic representation of a sensor system 1 according to one embodiment. The sensor system 1 can comprise a plurality of inertial sensors, for example at least one rotational rate sensor 11 along with at least one acceleration sensor 12. The inertial sensors 11, 12 can, for example, be sensors based on microelectromechanical systems (MEMS). In principle, however, the principle described here can also be applied to any other inertial sensor.

The rotational rate sensor 11 can, for example, provide sensor data for a rotational motion (yaw rate) about a spatial axis. In particular, the rotational rate sensor 11 can also provide sensor data for rotational rates of, for example, two or three spatial axes orthogonal to one another. As a rule, the sensor data are provided in relation to a reference system of the particular sensor and thus of the sensor system 1 having this sensor.

The acceleration sensor 12 can also provide sensor data for translational acceleration along a spatial axis, for example. Here as well, the acceleration sensor 12 can provide acceleration values for two or three spatial axes orthogonal to one another, for example. As a rule, these acceleration values are also provided in relation to a reference system of the particular sensor and thus of the sensor system 1.

The values detected by the inertial sensors 11, 12 can, for example, be made available at an input interface 21 of a processing apparatus 20. The sensor values can be provided in the form of analog or digital values. In particular, the sensor values can be provided at a predefined first sampling rate and/or be detected by the input interface 21.

The sensor values received can be temporarily stored, if applicable. If applicable, pre-processing such as filtering or the like is also possible. This can be carried out either in the input interface 21 or alternatively in the downstream processing device 22. In particular, unless otherwise indicated, the direction of motion along with the orientation are preferably used as averaged values for the exemplary embodiments described here.

The processing device 22 can, for example, process the sensor data from the acceleration sensor(s) 12 in order to derive information therefrom about a motion, direction of motion or speed. For example, the acceleration values for the individual spatial directions can be integrated in order to calculate therefrom values for the particular speed components. Due to repeated integration of the speed components, the distance traveled can also be ascertained.

Similarly, the processing device 22 can also process sensor data from the rotational rate sensor(s) 11 and, for example, obtain information therefrom about an orientation/alignment of the sensors 11 and thus of the sensor system 1. The sensor values of the rotational rate sensors 11 can also be integrated for this purpose, for example.

Due to inaccuracies or sensor errors, in particular an offset/bias or other errors (e.g., axis errors and sensitivity errors), the sensor values received may contain errors. Here, the integration of the sensor values described above means that the data ascertained, such as speed, distance and orientation, can increasingly deviate from the actual motion of the sensor system as the integration time increases.

Therefore, processing for detecting along with correcting or compensating for such inaccuracies can be provided in the processing device 22 of the processing apparatus 20.

While conventional concepts for correcting or compensating for deviations are, as a rule, based on the use of additional information, for example from a satellite navigation system (GNSS) or the like, the following describes concepts that also make possible the determination and adjustment of parameters for correcting or compensating for system or sensor errors when sensor systems 1 are in motion, and in particular also during operation for determining navigation data such as speed, distance, direction of motion, etc.

In one possible embodiment, the compensation or correction of the sensor values can be carried out on the basis of an analysis of the speed, for example. The basic principle of such an approach can, for example, be based on recognizing a state of the sensor system 1, in which the sensor system 1 moves at least approximately at a constant speed and thereupon comparing an average speed during such a phase with the current development of the speed. Parameters can be derived from this comparison in order to adjust a correction model for compensating for sensor errors. On the one hand, the correction model can be used to compensate for possible errors in the raw data from the sensors 11, 12. In addition, by means of the correction model, an adjustment or correction of previously ascertained position or motion data can also be carried out. Thus, position or motion data previously ascertained on the basis of data from the inertial sensors 11, 12 can be modified by means of this correction model in order to compensate for an offset, drift or other deviation.

FIG. 2 is a flow chart that may be based on a method for operating a sensor system 1, in particular an inertial sensor system, according to one embodiment.

Initially, sensor data can be received from one or more inertial sensors 11, 12, in particular at least one acceleration sensor 12.

Preferably, sensor data can be received from at least one acceleration sensor 12 and one rotational rate sensor 11.

In step S 11, the data from one or more sensors, in particular sensor data from the sensor system 1, can be evaluated in order to detect a stable state of motion of the sensor system 1. In the case of this exemplary embodiment, this stable state of motion can in particular be a state in which the average orientation of the sensor system is at least approximately constant in relation to the average direction of motion of the sensor system. For this purpose, for example, the direction of motion along with the orientation of the sensor system 1 can be observed and averaged over a predefined period of time. In principle, any suitable sensor data that are available can be evaluated for such an analysis of the sensor values. In addition, any suitable method, such as a frequency analysis of the available sensor data or the like, can also be used for evaluating an at least approximately constant direction of motion. Additionally or alternatively, it is also possible to analyze the course of the direction of motion using a trained neural network or in another suitable manner.

On the basis of the sensor data received, a current motion, in particular the current vectorial speed of the sensor system 1, can be ascertained in a step S 12. Any suitable approach, in particular, for example, the integration of acceleration values, can be used for this purpose. Furthermore, the orientation of the sensor system 1 can be ascertained using sensor values from a rotational rate sensor 11, for example.

In step S 13, the ascertained (vectorial) speed of the sensor system 1 can be monitored in order to determine therefrom a direction of motion over time. An average direction of motion can be determined therefrom over a corresponding time interval. Similarly, the orientation of the sensor system 1 can be evaluated in order to determine therefrom an average orientation of the sensor system 1 in the time interval under consideration. For example, a time span of between 1 second and 3 seconds can be used as the time interval.

From the values calculated in this way, a difference between the change in the direction of motion and the change in orientation can be calculated in step S 14. Such a difference corresponds, for example, to a change in the alignment of the sensor system 1 in relation to the (averaged) direction of motion.

If the analysis carried out in step S 11 indicates an at least approximately stable state of motion, parameters for a correction model for compensating for sensor errors can be ascertained in step S 15. For this purpose, for example, an approach can be used that adjusts the parameters for the correction model for compensating for the sensor errors in such a way that the difference between the previously calculated change in the direction of motion and the value of the average change in the orientation of the sensor system 1 is minimized, i.e., preferably approaches zero.

The correction model for the compensation of sensor errors can, for example, be a mathematical model on the basis of a probabilistic filter. In particular, the correction model can comprise a so-called Kalman filter, for example. In principle, however, any other suitable correction models or filter approaches are also possible.

Due to system-related properties and interferences, both the sensor values from the inertial sensors 11 and 12 as well as the results when calculating the speed values may be subject to uncertainties. Therefore, these uncertainties can also be included in the adjustment of the parameters for the correction model. For example, inaccuracies or tolerances can be assigned to the input data such as acceleration, rotational rate, etc., and a resulting uncertainty or accuracy can be derived therefrom. Additionally or alternatively, it is also possible to assign uncertainties or accuracy values to resulting quantities such as speed, orientation, etc. Furthermore, at the beginning or during initialization, for example, initially a high level of uncertainty can be assumed due to a lack of data. In the further course of operation, the uncertainty of the values can thereupon decrease or the underlying accuracy of the values can increase in accordance with the data obtained. In principle, any suitable approach for assessing the uncertainties or the underlying accuracy is possible for this purpose. This information can also be included in the ascertainment of the parameters for the correction model. For example, the individual variables can be weighted according to the underlying inaccuracies.

As can be seen from these explanations, the determination or adjustment of parameters for the correction model for compensating for the sensor values is carried out in an operating state or an operating phase in which current measured values, i.e., speed, direction of motion, orientation, etc., can be ascertained. Thus, the dynamic adjustment of the correction model does not require any interruption to the operational mode.

Due to such continuous dynamic adjustment of the correction model, stable, reliable, and relatively accurate data regarding speed, direction of motion, position, etc., can thus be obtained and provided over a significantly longer period of time. In particular, possible deviations such as an offset, a drift or the like in previously ascertained position or motion data can also be (subsequently) corrected using this correction model.

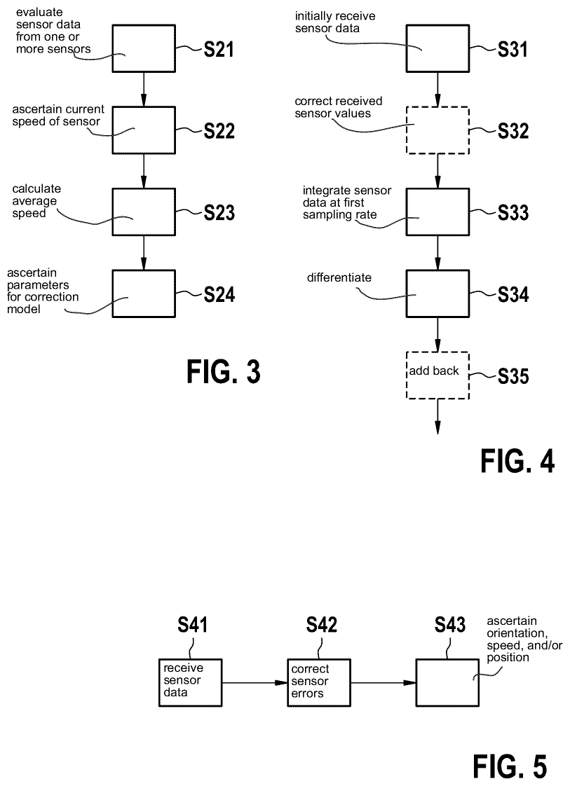

Analogous to an adjustment of parameters for a correction model for compensating for sensor values on the basis of monitoring the direction of motion and the orientation of the sensor system 1, it is also possible to additionally or alternatively adjust parameters for the correction model by evaluating the speed or a variation over time of the speed. One possible concept is explained below with reference to FIG. 3.

Here as well, sensor data are received from one or more inertial sensors 11, 12. Preferably, sensor data can be received from both at least one acceleration sensor 12 and one rotational rate sensor 11.

In step S 21, the data from one or more sensors, in particular sensor data from the sensor system 1, can be evaluated in order to detect a predetermined stable state of motion, such as an at least approximately constant speed of the sensor system 1. As a constant speed, for example, a course of the speed over a predefined period of time can be considered, in which the speed remains within a predefined value range/tolerance band. For such an analysis of the sensor values for determining an at least approximately constant course of the speed, any suitable sensor data that are available can be evaluated. In addition, any suitable method, such as a frequency analysis of the available sensor data or the like, can also be used to evaluate an at least approximately constant speed. Additionally or alternatively, it is also possible to analyze the course of the speed using a trained neural network or in another suitable manner.

On the basis of the sensor data received, a current speed of the sensor system 1 can be ascertained in a step S 22. For example, the values from the acceleration sensor 12 can be integrated for this purpose.

In a step S 23, an average speed can be calculated for a predefined time window from the values ascertained for the speed of the sensor system 1. Any suitable time window can be used for this purpose. For example, a time span of between 1 second and 3 seconds can be used as the time window.

If there is at least an approximately constant speed, parameters for a correction model for compensating for sensor errors can be ascertained in step S 24. The adjustment of the parameters for the correction model can be carried out using a minimization of the difference between the calculated average speed according to step S 23 and the speed estimated as the constant speed of the sensor system from step S 21. In particular, the method referenced in the introduction can also be implemented.

For example, an approach can be used that adjusts the parameters for the correction model for compensating for the sensor errors in such a way that one difference is minimized, i.e., preferably approaches zero.

The underlying correction model for the compensation of sensor errors can also be a mathematical model on the basis of a probabilistic filter, for example. In particular, the correction model can comprise a so-called Kalman filter, for example. In principle, however, any other suitable correction models or filter approaches are also possible.

Data for the uncertainties of the sensor values and/or the resulting variables such as speed, orientation etc., can also be included in the ascertainment of the parameters for the correction model.

In the two methods described above for ascertaining parameters for the correction model, average values for speed, rotational rate and/or orientation, among other things, are used. In addition to conventional averaging, in which all sensor values within a predefined time interval are weighted equally, any other approach is also possible. For example, the individual data points can be assigned an individual weighting according to their temporal position in the time window with the values to be taken into account in each case. In this manner, the dynamics of the calculated average values can be adjusted accordingly.

For specifying whether the sensor system 1 is in a stable state of motion, various suitable approaches are possible in principle. For example, the variation or change in translational speed along with rotational rate can be compared with predefined threshold values. Here, for example, translational speed or rotational rate can be averaged over a predetermined period of time and these average values can be analyzed accordingly. In addition, any other suitable models, such as statistical models, are also possible. The stable state of motion can also be detected by means of simple machine learning methods or the like.

In particular, a classification of the state of motion is possible, for example. For example, a group of classes of various states of motion can comprise, for example, a first class in which the sensor system 1 is completely at a standstill. A further, second class can, for example, be assigned to states of motion in which the sensor system 1 is at a standstill averaged over predefined time intervals. The sensor system 1 can also move within this time interval, for example vibrate, swing back and forth or the like. A third class of states of motion can, for example, be assigned to motions in which the sensor system 1 is in a uniform motion. Finally, a fourth class of states of motion can, for example, be assigned to motions in which the sensor system 1 moves uniformly on average, but can also carry out arbitrary, random or irregular motions for a short time. This can be the case, for example, if such a sensor system 1 is attached to the wrist of a user, wherein the user moves around and swings their arms, so that the sensor system on the wrist swings back and forth during the motion on the arm. However, the classification into four classes listed here is only understood as an example. In addition, any other types of classifications for subdividing the states of motion, in particular for classifying various stable states of motion, are also possible.

For error compensation or the creation of a correction model, in the case of a static state the correction can, for example, be carried out based on a probability of one or more of the following assumptions (wherein other assumptions can also be made in principle):
a) the translational speed is at least approximately zero;
b) the rotational rate is approximately zero or corresponds to an offset of the rotational rate sensor;
c) an amplitude and/or direction of a value from the acceleration sensor corresponds to an amplitude or direction of the acceleration due to gravity transformed into the coordinate system of the sensor.

Here, the corrections can be carried out according to measurements or estimates by means of a probabilistic filter or in any other manner. In particular, the correction can be carried out for all of the above-mentioned classes of stable directions of motion if the correction here is applied for a time window within which a stable state of motion results on average.

In addition, other correction approaches, such as specifications for an average speed, an average acceleration or the like, can also be applied if applicable.

Such a correction approach also has a direct or indirect influence on the ascertained or corrected position, speed, alignment along with sensor errors of the acceleration sensor and rotational rate sensor. If, for example, a correction is carried out for a dedicated speed of zero, the position along with the linear acceleration are updated. The updating of the linear acceleration leads to an error compensation of the acceleration along with the orientation. The error compensation of the acceleration thereupon leads to an error compensation of the acceleration sensor, and the correction of the orientation leads to an error compensation of the rotational rate, which in turn leads to an error compensation of the rotational rate sensor. Thus, all states are corrected. Here, the degree of impact can be based on the cross-covariance estimated by the probabilistic filter, which results from the noise propagation and the probabilities defined in the probabilistic filter.

When processing sensor values for determining speed, direction of motion, motion path, orientation, position, etc., as a rule, the sensor values are detected, provided and processed at a first, relatively high sampling rate. This sampling rate can range from a few 100 Hz to a few kilohertz. The processing of all data at such a high sampling rate may require high computing power, if applicable. In addition, transmission paths with a suitable high bandwidth must also be provided for forwarding the corresponding data and results.

For further optimization and for increasing efficiency, the sampling rate can be reduced in a first processing step, so that the subsequent steps only have to be carried out at a second, lower sampling rate or the data can be forwarded at this second, lower sampling rate. The second sampling rate can be in the range from a few 10 Hz to a few Hertz, for example.

A possible method for reducing the sampling rate is described below in connection with FIG. 4. The method is based on the basic principle that the data are initially received at the first, higher sampling rate and integrated over a plurality of iteration steps. The integrated values can subsequently be differentiated according to the time interval of the integration and these differentiated values can be output at the second sampling rate.

At the beginning, an initialization can initially take place in which all speed values and rotational rate values are reset, for example to 0.

In step S 31, sensor data are initially received from the sensors 11, 12 of the inertial sensor system 1 at the first sampling rate.

Optionally, in step S 32, the received sensor values can thereupon be corrected according to a correction model, if applicable. For example, suitable scaling can be carried out. Additionally or alternatively, an offset can also be adjusted or removed.

In step S 33, the received sensor data are integrated at the first sampling rate, i.e., added up. Here, for example, the data can be processed in a reference system of the sensor system 1. Since the sensor system 1 can move over time and, in particular, a rotation of the sensor system 1 can also be carried out, the corresponding reference system of the sensor system 1 can change over time. In order to take this change in the reference system into account, it is possible, for example, to transform the already integrated data into the in each case current reference system of the sensor system 1. The current sensor data can subsequently be added to the transformed data for integration. In this manner, the integration result is always available in the form of the reference system according to the current alignment of the sensor system 1. Alternatively, it is also possible in principle to carry out the integration on the basis of any fixed reference system. For example, the original reference system can be used as a basis when initializing the sensor system 1. Thereupon, the sensor data can be transformed to this fixed reference system before integration. In particular, a transformation from the reference system of the sensor system 1 to a global reference system (for example, in relation to the Earth's gravitational field) is also possible. For example, a linear approximation can be used here for the integration and in particular for the transformation of the reference system. In particular, trigonometric functions or non-linear formulas with one or more trigonometric functions can be approximated at least in portions by suitable linear equations.

After the sensor data has been integrated over at least two integration steps, for example over a predefined time interval or for a predefined number of integration or iteration steps, the result of this integration can be differentiated in step S 34 according to the integration time interval. In this manner, new data for sensor values corresponding to a second, significantly lower sampling rate can be obtained after each differentiation. A suitable linear approximation can also be used for this differentiation of the sensor values, if applicable. Various linear approximations can be used for this purpose, in particular on the basis of the sensor data. For example, a different linear approximation can be used for high rotational rates than for low rotational rates. In addition, any other distinctions for selecting a suitable linear approximation are of course also possible. Due to such linear approximations, simpler computational structures can also be used, which are not capable of executing complex, partially trigonometric functions. In addition, due to the linear approximation, the required computing power and computing time can be reduced.

If the sensor values were corrected according to a correction model in the optional step S 32, the errors that have previously been compensated for can be added back to the sensor values at the now lower, second sampling rate in the likewise optional step S 35. In this manner, sensor values at the second sampling rate, which still have the original error characteristics, are available for further processing. Thus, the sensor values provided in the second sampling rate can also be used to create parameters for models for compensating for errors. In particular, the provided sensor data at the second sampling rate can also be used to perform the method described above for adjusting the parameters for the correction models.

In principle, the first sampling rate along with the second sampling rate can be fixed. However, it is also possible to dynamically adjust the first sampling rate and/or the second sampling rate during operation. For example, the first sampling rate can be adjusted on the basis of a data rate of the sensor system 1. In addition, any other approach to varying the first sampling rate is also possible. The second sampling rate can, for example, be adjusted or predefined by a downstream processing device. As a result, it is possible to provide the data at a second sampling rate that meets the requirements for further processing. For example, the second sampling rate can be adjusted on the basis of a data rate for transmitting the output data. It is also possible to adjust the second sampling rate on the basis of the processing power of a downstream processing device. In addition, any other criteria for dynamic adjustment of the second sampling rate are also possible for the second sampling rate.

The components and method elements described above can be used, for example, in a sensor system 1 having inertial sensors 11, 12, in order to increase accuracy, long-term stability along with processing speed. As a result, sensor systems that can efficiently and precisely provide position information, motions, motion sequences, etc. can be realized.

As already explained above, the parameters for the compensation of sensor errors can be ascertained and adjusted during operation, i.e., in parallel with the determination of the motion data. As a result, such sensor systems 1 are not limited to static, previously specified correction models. Due to the integration of compensation of sensor errors for processing the sensor data, it is also possible to dynamically adjust the parameters for the correction models during operation. A possible sequence for such a method for processing sensor data from a sensor system 1 with a plurality of inertial sensors 11, 12 is shown, for example, in FIG. 5.

In step S 41, sensor data can be received from the sensors 11, 12, in particular one or more rotational rate sensors 11 along with one or more acceleration sensors 12.

In step S 42, sensor errors in the received sensor data are corrected by a dynamically adjustable correction model. The parameters for this correction model can be adjusted dynamically using currently ascertained values for orientation, speed and/or position. In particular, the methods described above can be used for ascertaining or adjusting parameters for correction models.

In step S 43, orientation, speed and/or position along with, if applicable, any other suitable parameters can be ascertained. Furthermore, previously ascertained position or motion data can also be modified or corrected on the basis of the adjusted correction model, if applicable.

The determination of the parameters for the correction model along with the ascertainment of the speed can also be carried out in particular at a reduced second sampling rate, wherein this second sampling rate, as already described above, is lower than the first sampling rate at which the sensor data are provided by the sensors 11, 12.

In summary, the present invention relates to a method for operating and calibrating an inertial sensor system. In particular, a concept is presented that makes it possible to execute parameters for a correction model for compensating for sensor errors during operation. The parameters can be ascertained in particular by evaluating a course of the speed.

Additionally or alternatively, the parameters can be ascertained by evaluating a course of a direction of motion.

In addition, the present invention relates to a method for reducing the data rate of sensor data in an inertial sensor system. For this purpose, the original sensor data can be pre-processed and integrated at an initial sampling rate. Subsequently, integrated values are differentiated according to a second, lower sampling rate.

What is claimed is:

1. A method for operating an inertial sensor system, comprising the following steps:
detecting a stable state of motion using sensor data of the inertial sensor system;
ascertaining a current speed and a current orientation using sensor data from the inertial sensor system;
calculating an average direction of motion and an average orientation for a predetermined time interval using the ascertained current speed and orientation;
calculating a difference between a change in the average direction of motion and a change in the average orientation; and
adjusting parameters for a correction model for compensating for sensor errors of the inertial sensor system using a minimization of the difference between the changes in the average direction of motion and the average orientation, when the stable state of motion has been detected.

2. The method according to claim 1, wherein the adjusting of the parameters for the correction model is carried out only when the speed is greater than a predetermined threshold value.

3. The method according to claim 1, wherein the method further comprises ascertaining inaccuracies for the detected stable state of motion, and/or the average direction of motion and/or the change in orientation, and wherein the adjusting of the parameters for the correction model is carried out using the ascertained inaccuracies.

4. The method according to claim 1, wherein the correction model for compensating for sensor errors includes a probabilistic filter including a Kalman filter.

5. The method according to claim 1, wherein the detecting of the stable state of motion is carried out using the sensor data and/or data from at least one further sensor.

6. The method according to claim 1, wherein the detecting of the stable state of motion is carried out using a pre-trained neural network.

7. The method according to claim 1, wherein the calculating of the average direction of motion and/or the average orientation is carried out in each case for a time window of one to three seconds.

8. The method according to claim 1, wherein the calculating of the average direction of motion and/or the average orientation is carried out in each case using a predefined weighting of individual speed values and/or rotational rate values.

9. An apparatus for processing sensor data from an inertial sensor system, comprising:
a processing device configured to receive and process sensor data from sensors of the inertial sensor system;
wherein the processing device is configured to:
detect a stable state of motion using sensor data of the inertial sensor system,
ascertain a current speed and a current orientation using sensor data from the inertial sensor system,
calculate an average direction of motion and an average orientation for a predetermined time interval using the ascertained current speed and orientation,
calculate a difference between a change in the average direction of motion and a change in the average orientation, and
adjust parameters for a correction model for compensating for sensor errors of the inertial sensor system using a minimization of the difference between the changes in the average direction of motion and the average orientation, when the stable state of motion has been detected.

10. A sensor system, comprising:
an acceleration sensor;
a rotational rate sensor; and
an apparatus configured to process sensor data,
wherein the apparatus configured to receive and process sensor data from the acceleration sensor and the rotational rate sensor, and wherein the apparatus includes:
a processing device is configured to:
detect a stable state of motion using the sensor data,
ascertain a current speed and a current orientation using the sensor data,
calculate an average direction of motion and an average orientation for a predetermined time interval using the ascertained current speed and orientation,
calculate a difference between a change in the average direction of motion and a change in the average orientation, and
adjust parameters for a correction model for compensating for sensor errors of the inertial sensor system using a minimization of the difference between the changes in the average direction of motion and the average orientation, when the stable state of motion has been detected.
